(19) United States
(12) Patent Application Publication
(10) Pub. No.: US 2005/0042133 A1
(43) Pub. Date: Feb. 24, 2005

(54) Chemical analyzer probe with chemical selective filter

(75) Inventor: Stephen T. Staphanos, Long Beach, CA (US)

Correspondence Address: David C. Bohn;Westman, Champlin & Kelly, Suite 1600, 900 Second Avenue South, Minneapolis, MN, 55402-3319, US

(73) Assignee: Rosemount Analytical Inc., Anaheim, CA (US)

(21) Appl. No.: 10/646,475

(22) Filed: Aug. 22, 2003

(51) Int. Cl. G01N 21/00

(52) U.S. Cl. 422/50; 73/31.07; 73/64.56; 422/58

(57) ABSTRACT

A chemical analyzer probe includes a gland extending from a tubular end to a second gland end connectable to a chemical analyzer. The gland has a sealing surface that seals to the opening. A porous tubular filter is joined to the tubular end of the gland and forms a filter cavity holding a filter fluid. A coating on the porous tubular filter is formed of a chemically selective material that allows a first chemical in the process fluid to flow into the filter fluid, while excluding a second chemical in the process fluid. A sensor couples to the filter fluid for sensing and connectable to a chemical analyzer through the second gland end.

### FIELD OF THE INVENTION

The present invention relates to chemical analyzers and in particular to chemical analyzer probes that can be inserted into containers of process fluid.

### BACKGROUND OF THE INVENTION

A wide variety of types of chemical analyzers are used to measure chemical properties of process fluids. The process fluids are often mixtures of particles, molecules and ions which differ depending on the particular application. In the case of an exhaust gas analyzer, a process gas may contain unburned particles of fuel, carbon dioxide, carbon monoxide, nitrous oxide and other chemicals. In the case of a pH analyzer, a process liquid may contain water, carbon dioxide, and ions of various carbon and sulfur compounds.

In some applications, chemical analyzers are difficult to maintain because the process fluid includes undesired particles, molecules or ions of compounds that either damage the chemical sensor or that cause erroneous readings of a chemical property of one of the components of the process fluid. The use of filters on chemical analyzers is known, but these filters may not successfully protect the chemical sensor in difficult applications without unduly slowing the response time of the analyzer.

A method and apparatus are needed to provide improved protection from undesired components of process fluids without unduly slowing the response time of the analyzer.

### SUMMARY OF THE INVENTION

Disclosed is a chemical analyzer probe that can be inserted in an opening on a container of process fluid. The probe includes a gland extending from a tubular end that can be inserted in the opening to an outer second gland end that can be connected to a chemical analyzer. The gland has a sealing surface that seals to the opening.

The chemical analyzer probe includes a porous tubular filter that is joined to the tubular end of the gland. The porous tubular filter extends to a closed end in the process fluid to form a filter cavity holding a filter fluid.

A coating is deposited on the porous tubular filter. The coating is formed of a chemically selective material that allows a first chemical in the process fluid to flow into the filter fluid, while excluding a second chemical in the process fluid. A sensor couples to the filter fluid for sensing and connects to a chemical analyzer through the second gland end.

### BRIEF DESCRIPTION OF THE DRAWINGS

FIG. 1 illustrates an embodiment of a chemical analyzer probe.

FIG. 2 illustrates an embodiment of a pH probe.

FIG. 3 illustrates an embodiment of a contact type conductivity probe.

FIG. 4 illustrates an embodiment of non-contact type of conductivity probe.

FIG. 5 illustrates an embodiment of an ISFET probe.

FIG. 6 illustrates an embodiment of a process gas probe.

FIG. 7 illustrates an embodiment of a porous tubular filter with a coating of chemical selective material inside the filter.

FIG. 8 illustrates an embodiment of a porous tubular filter with a coating of chemical selective material on the outside of the filter.

### DETAILED DESCRIPTION OF THE PREFERRED EMBODIMENTS

In the embodiments illustrated below, a chemical analyzer probe includes a porous tubular filter that is coated with a chemically selective coating and that forms a filter cavity containing a filter fluid. The filter fluid contacts a chemical sensor for sensing a chemical property. The chemically selective coating allows a first chemical in the process fluid to diffuse rapidly into the filter fluid, while the coating excludes one or more other chemicals present in the process fluid. The arrangement provides sensing of the desired chemical characteristics by filtering out undesired chemicals that would otherwise interfere with sensing. The arrangement also provides corrosion protection for the chemical sensor. An elongated tubular shape of the probe provides a large surface area and a large filter fluid volume that increase speed and accuracy of the probes. The probes can be used with either liquid or gas and are easy to calibrate and maintain because particles and chemical contaminants in the process fluid are kept away from the chemical sensors in the probes.

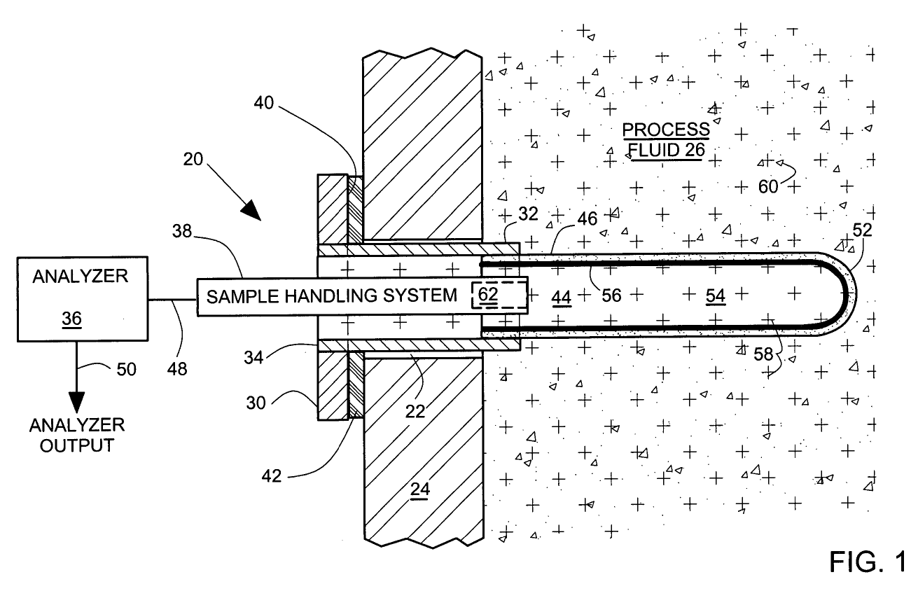

FIG. 1 illustrates an embodiment of a chemical analyzer probe 20 that is inserted in an opening 22 in a container 24 that contains a process fluid 26. The container 24 can be a main pipe, a bypass pipe, a tank, a flue or other container depending on the application.

The analyzer probe 20 includes a gland 30 that extends from a tubular end 32 that is inserted through the opening 22 to an outer second gland end 34 that provides connection to a chemical analyzer instrument 36 via a sample handling system 38. The gland 30 has a sealing surface 40 that seals to the opening 22, typically using a gasket 42, so that process fluid 26 does not leak out of the container 24. The gland 30 can vary considerably in size, shape and material, depending on the configuration of the opening 22, the chemical species that is being sensed, whether the process fluid 26 is liquid or gas and whether a chemical sensor 62 is mounted in the probe 20 or mounted in the analyzer 36. The gasket 42 can seal to an outer surface as illustrated or can be an O-ring that slides in the opening 22 to form a seal. If desired, a gland shape and sealing surface can be selected to conform to 3A sanitary standards, hot tap probe tubes, or flanges of various sizes and types, depending on the needs of the application. The gland 30 is clamped in place using bolts or clamps (not illustrated) and is thereby fastened and electrically connected to process ground at the container 24. For many applications, gland 30 can be made of stainless steel.

The sample handling system 38 places the chemical sensor 62 in contact with a filter fluid 44 and couples to the analyzer instrument 36 along a line 48. The term “sample handling system,” as used in this application means a connector that is part of the probe 20 that adapts the probe 20 for connection to the analyzer 36. The sample handling system 38 can be an electrical connector, a fluid connector or an optical connector. The chemical analyzer instrument 36 provides an analyzer output 50 that represents one or more chemical properties of the filter fluid 44 such as pH, fluid conductivity, ion specific measurement, gas concentration and the like, depending on the type of chemical sensor 62 used to contact the filter fluid 44.

Depending on the application, the analyzer instrument 36 may be locally mounted to the probe 20 or may be remotely mounted. In some applications, the chemical sensor 62 can be mounted in the gland 30 or in a porous tubular filter 46 that is joined to the tubular end 32, in which case an optical or electrical signal is coupled along the line 48 to the analyzer 36. In other applications, the chemical sensor 62 can be mounted in the analyzer 36, in which case the line 48 comprises a hollow tube that couples the filter fluid 44 to the analyzer 36 for sensing. In both cases, the sensor 62 is in contact with and senses the filter fluid 44.

The porous tubular filter 46 that is joined to the tubular end 32 extends to a closed end 52 in the process fluid 26 to form a filter cavity 54 holding the filter fluid 44. To prevent leakage, the porous tubular filter 46 is sealed to the gland 30 by means of welding, brazing, soldering or adhesive. The filter cavity 54 can be sealed at the gland 30 by a sensor 62, the sample handling system 62, or a separate seal in the gland 30. Alternatively, the filter cavity 54 can be sealed in the gland to a drain or vent to provide flow of fresh sample fluid over the sensor 62. The process fluid 26 is typically at a higher pressure than a pressure at the vent or drain so that flow is induced by the pressure difference.

In a preferred arrangement, the porous tubular filter 46 has an elongated tubular shape as illustrated. The elongated tubular shape provides a large surface area on an outer surface of the porous tubular filter 46 to allow selected components of the process fluid 26 to pass rapidly through the outer surface. The elongated tubular shape also provides a large volume of filter fluid 44 inside the porous tubular filter 46. The large volume helps to ensure that the filter fluid 44 in not contaminated and is not reduced in chemical concentration by its chemical or electrical interactions with the sensor 62. In a preferred arrangement, the porous tubular filter 46 has a filter wall thickness that is no more than 1 millimeter to provide low delay time and low time constants for the response of the probe to changes in chemical concentrations. The porous tubular filter 46 is preferably made from porous material including glass frit, ceramics, Hastalloy, nickel or a composite material selected to provide good corrosion resistance for a particular application.

A coating 56 is deposited on the porous tubular filter 46. The coating 56 is formed of a chemically selective material that allows a first chemical 58 (represented by +symbols) in the process fluid 26 to diffuse into the filter fluid 44, while excluding a second chemical 60 (represented by triangles) in the process fluid 26. The exclusion of the second chemical 60 need not be total exclusion in order for the arrangement to provide benefits. The chemically selective coating can comprise materials with characteristics that range from hydrophobic to hydrophilic depending on the needs of the application. In particular, polyethersulfone, acrylic polymer and polysulfone materials can be used to provide hydrophilic characteristics in the chemically selective layer 56. The chemically selective layer 56 can also comprise ion selective materials such as polypropylene, polystyrene, Teflon and silicone rubber. Chemically selective layer 56 can be used to exclude undesired chemicals or ions such as SO₃, H₂SO₄, HCl, NH₃ from the filter fluid 44.

By placing the chemically selective layer 56 directly on the porous tubular filter 46, response times of the probe 20 are improved in comparison to passing the process fluid 26 through a series of separate filters that are connected together by tubes or passageways.

The sensor 62 contacts the filter fluid 44 for sensing and is connected to the chemical analyzer 36 through the second gland end 34. While sensor 62 is illustrated at a location that is in the probe 20 in FIG. 1, the sensor 62 can alternatively be placed inside the analyzer 36 when there is flow through the filter cavity 54.

In operation, process fluid 26 can include a number of chemical ions or molecules and can also include particles. The sensor 62 is adapted to sense only a selected ion or molecule, or a selected group of ions or molecules, and the operation of sensor 62 is interfered with by other contaminating ions, molecules or particles in the process fluid 26. The porous tubular filter 46 blocks the flow of particles and also provides a mechanical support surface for the chemically selective coating 56. The chemically selective coating 56 allow the selected components to pass through the coating 56 and enter into the filter fluid 54.

In some applications, such as a gas sensing applications, the filter fluid 24 can be comprised entirely of components of the process fluid 26 that have passed through the chemically selective coating 56. In other applications, such as pH sensing applications, the filter fluid 44 can comprise a buffer solution in addition to chemical components that have passed through the chemically selective coating 56.

In some applications, the filter fluid 44 is relatively stationary and relies on the diffusion of chemicals into and out of the filter cavity 54 through the chemically selective coating 56. In other applications, the filter cavity connects to a drain or vent that is at a lower pressure than the process fluid 26, and there is a flow of filter fluid 44 through the probe 20 to provide fresh sample to the sensor 62 and improve speed. The drain or vent is typically included in the analyzer 36.

The analyzer 36 preferably includes electronic circuitry, typically a microprocessor system, that converts an electrical or optical signal from the sensor 62 into an output 50 that is calibrated and suitable for transmission over long distances to a control room. Analyzers of conventional design can be used with the probe 20.

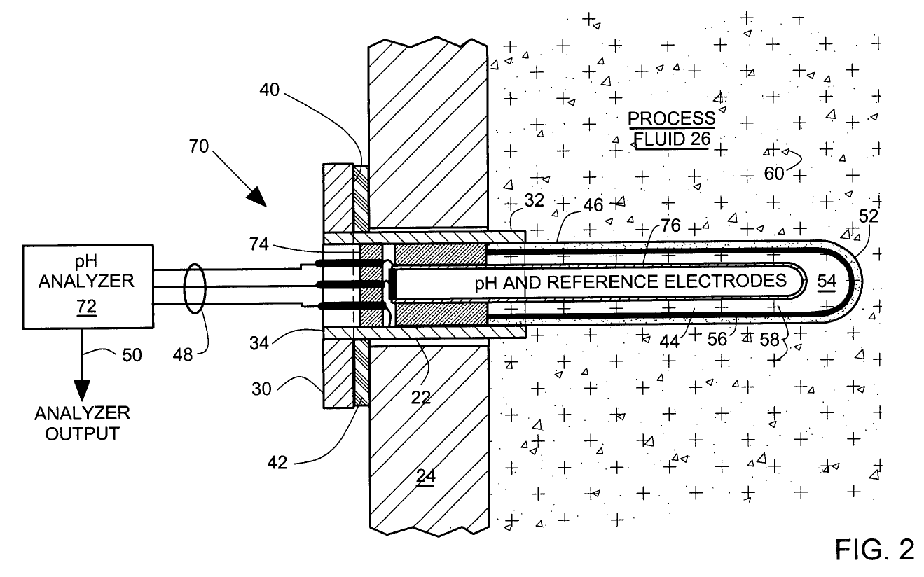

Several specific examples of probes are described below in connection with FIGS. 2-6.

FIG. 2 illustrates an embodiment of a pH probe 70. Reference numbers used in FIG. 2 that are the same as reference numbers used in FIG. 1 identify the same or similar features. In FIG. 2, a pH analyzer 72 is coupled via line 48 (which is a cable that includes three individual electrical leads) to an electrical connector 74 which serves as a sample handling system. Connector 74 has pins that are connected to a pH electrode, a reference electrode and a process ground connection. A pH sensor 76 includes both the reference electrode and the pH electrode. A pH sensor 76 which provides an optical output and a sample handling system that is an optical connector can also be used. The filter fluid 44 preferably comprises a pH buffer solution. In other respects, the probe 70 illustrated in FIG. 2 is similar to the probe 20 illustrated in FIG. 1.

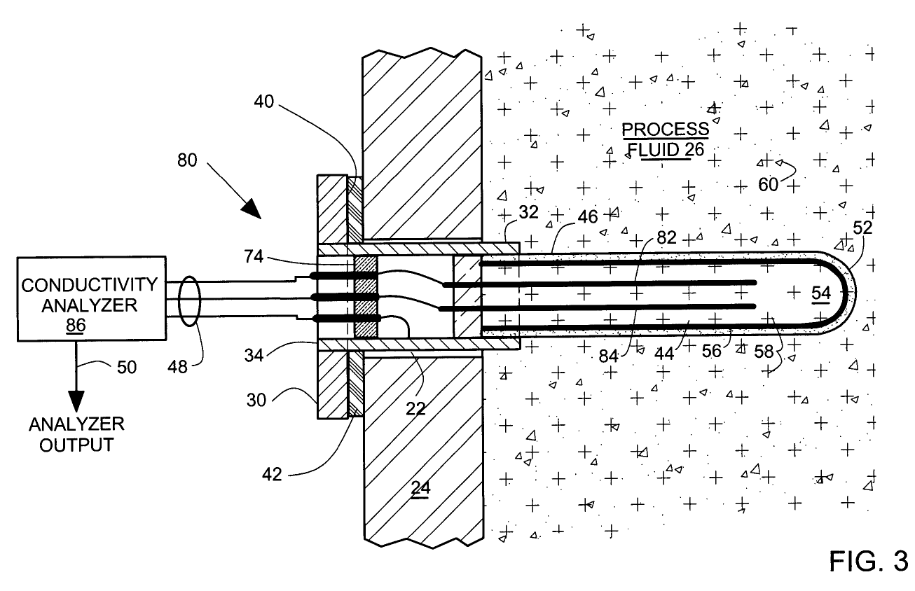

FIG. 3 illustrates an embodiment of a contact type conductivity probe 80. Reference numbers used in FIG. 3 that are the same as reference numbers used in FIGS. 1-2 identify the same or similar features. In FIG. 3, the contact type of conductivity probe 80 includes metal electrodes 82, 84 that are in direct contact with the filter fluid 44 and sense the electrical conductivity of the filter fluid 44. The electrical conductivity indicates a concentration of ionic chemicals in the filter fluid 44. An electrical connector 74 serves as a sample handling system and includes connector contacts that are connected to the metal electrodes 82, 84 and to process ground. A conductivity analyzer 86 is connected by line 48 (which is a cable with multiple conductors) to the electrical connector 74. In a preferred arrangement, a temperature sensor is also included in the probe 80 and connected to the conductivity analyzer 86 to provide temperature compensation. In other respects, the probe 80 illustrated in FIG.3 is similar to the probe 70 illustrated in FIG. 2.

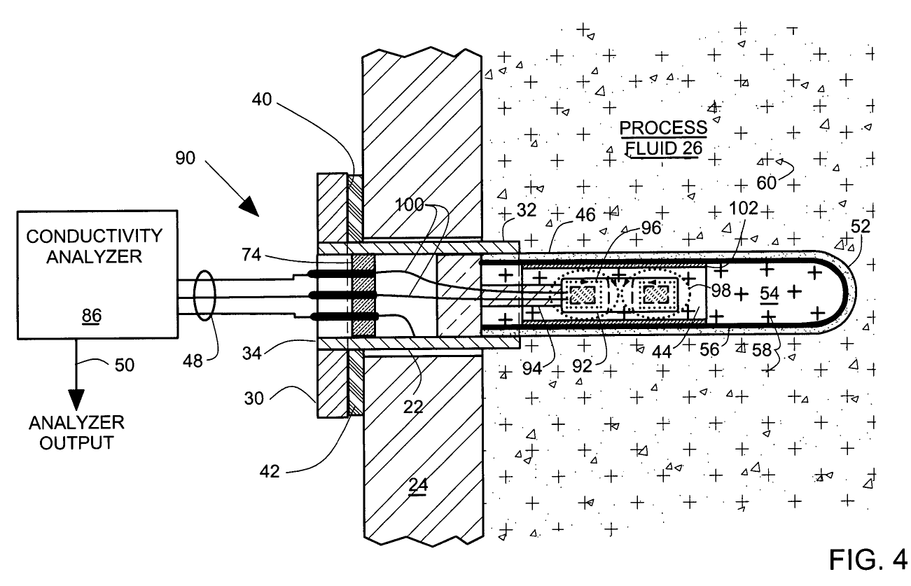

FIG. 4 illustrates an embodiment of a non-contact type of conductivity probe 90. Reference numbers used in FIG. 4 that are the same as reference numbers used in FIGS. 1-3 identify the same or similar features. In FIG. 4, a non-contact type of conductivity probe includes a toroidal magnet coil 92 mounted on a mounting pedestal 94. The toroidal magnet coil 92 carries an alternating excitation current 96 that induces alternating electrical current 98 in filter fluid 44 that surrounds the toroidal magnet coil. The magnitude of the electrical current 98 varies with the conductivity of the filter fluid 44. The toroidal magnet coil 92 senses the magnitude of the electrical current 98 and provides an output on leads 100 representative of fluid conductivity. An electrical connector 74 serves as a sample handling system and includes connector contacts that are connected to the leads 100 and to process ground. A conductivity analyzer 86 is connected by line 48 (which is a cable with three conductors) to the electrical connector 74. In a preferred embodiment, a thin electrically insulating tubular sleeve 102 is inserted in the porous tubular filter 46 surrounding the toroidal magnet coil 92. The electrically insulating sleeve 102 reduces short circuiting of the electrical current 98 through the porous tubular filter 46 and the coating 56. In a preferred arrangement, a temperature sensor is also included in the probe 90 and connected to the conductivity analyzer 86 to provide temperature compensation. In other respects, the probe 90 illustrated in FIG. 4 is similar to the probe 80 illustrated in FIG. 3.

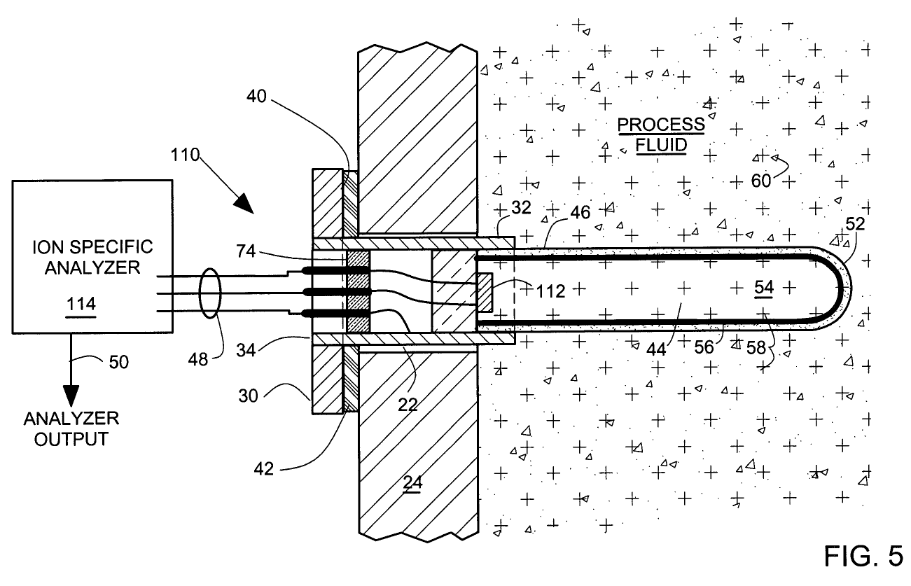

FIG. 5 illustrates an embodiment of an ISFET probe 110. Reference numbers used in FIG. 5 that are the same as reference numbers used in FIGS. 1-4 identify the same or similar features. In FIG. 5, the ion-specific field effect transistor (ISFET) type of specific ion probe 110 includes an ISFET 112 that is in contact with the filter fluid 44 and sense a concentration of a specific ion in the filter fluid 44. An electrical connector 74 serves as a sample handling system and includes connector contacts that are connected to the ISFET 112 and to process ground. An ion specific analyzer 114 is connected by line 48 (which is a cable with three conductors) to the electrical connector 74. It will be understood by those skilled in the art that the ISFET 112 can be replaced with other types of ion specific sensors as well. In a preferred arrangement, a temperature sensor is also included in the probe 110 and connected to the ion specific analyzer 114 to provide temperature compensation. In other respects, the probe 110 illustrated in FIG.5 is similar to the probe 80 illustrated in FIG. 3.

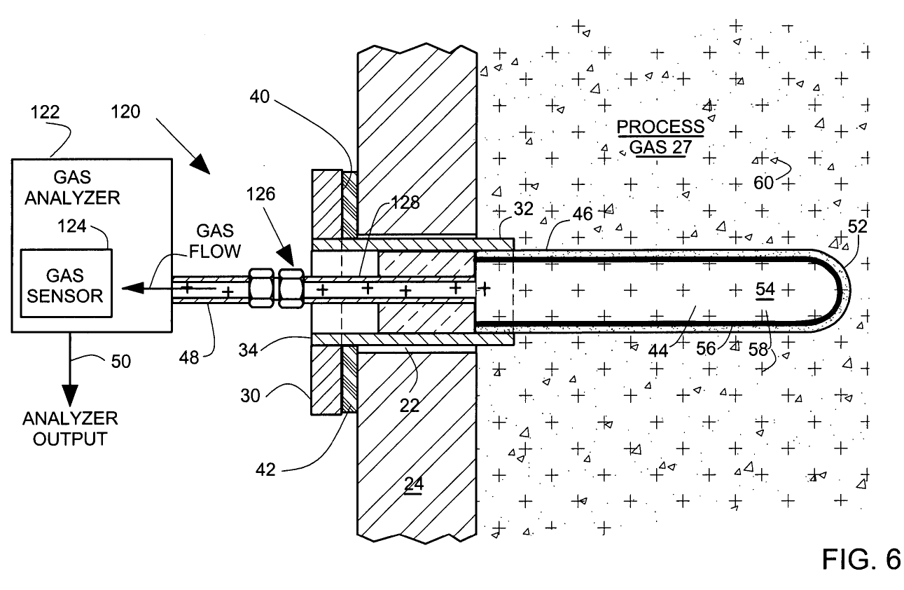

FIG. 6 illustrates an embodiment of a process gas probe 120 sensing a process gas 27. Reference numbers used in FIG. 6 that are the same as reference numbers used in FIGS. 1-5 identify the same or similar features. In FIG. 6, a gas analyzer 122 includes a gas sensor 124 that is coupled via line 49 (which is a hollow tube that carries filter fluid 44 to the gas sensor 124) to a tube fitting 126 which serves as a sample handling system. The tube fitting 126 includes a passageway 128 that couples the filter fluid 44 from the filter cavity 54 to the hollow tube 49. In other respects, the probe 120 illustrated in FIG. 6 is similar to the probe 20 illustrated in FIG. 1.

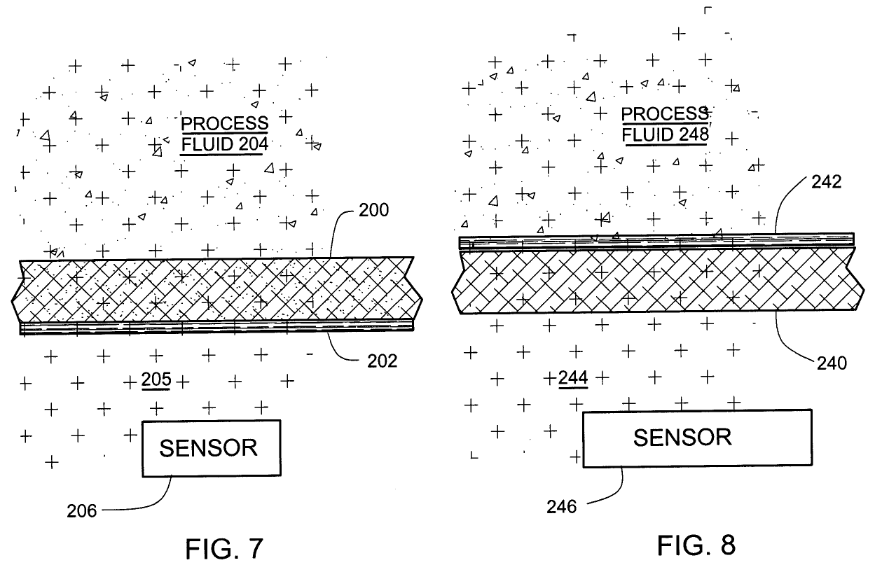

FIG. 7 schematically illustrates an embodiment of a porous tubular filter 200 with a coating of chemically selective material 202. The chemically selective material 202 is inside the porous tubular filter 200 along with a filter fluid 205 and a sensor 206. The chemically selective layer 202 is in direct contact with the filter fluid 205. In the arrangement shown in FIG. 7, the porous tubular filter 200 is in direct contact with a process fluid 204 (which can be a liquid or a gas) and shields the coating of chemically selective material 202 from plugging and contamination from particles in the process fluid 204.

FIG. 8 illustrates an embodiment of a porous tubular filter 240 with a coating of chemical selective material 242 on the outside of the porous tubular filter 240 in direct contact with a process fluid 248. In the arrangement shown in FIG. 8, the coating of chemically selective material 242 is in direct contact with a process fluid 248 (which can be a liquid or a gas) and shields the porous tubular filter 240 from corrosion by chemical species in the process fluid 204. The chemically selective layer 242 reduces concentration of undesired chemicals before the undesired chemicals can reach the porous tubular filter 240.

Although the present invention has been described with reference to preferred embodiments, workers skilled in the art will recognize that changes may be made in form and detail without departing from the scope of the invention.

1. A chemical analyzer probe insertable in an opening in a container of process fluid, comprising:
a gland extending from a tubular end insertable in the opening to a second gland end connectable to a chemical analyzer, the gland having a sealing surface sealable to the opening,
a porous tubular filter joined to the tubular end and extending to a closed end in the process fluid to form a filter cavity holding a filter fluid;
a coating deposited on the porous tubular filter, the coating being formed of a chemically selective material that allows a first chemical in the process fluid to flow into the filter fluid, while selectively excluding a second chemical in the process fluid; and
a sensor coupled to the filter fluid for sensing and connectable to a chemical analyzer through the second gland end.

2. The chemical analyzer probe of claim 1 wherein the chemically selective material comprises a hydrophobic material.

3. The chemical analyzer probe of claim 1 wherein the chemically selective material comprises a hydrophilic material.

4. The chemical analyzer probe of claim 3 wherein the hydrophilic material is selected from the group: polyethersulfone, acrylic copolymer, and polysulfone.

5. The chemical analyzer probe of claim 1 wherein the chemically selective material comprises an ion selective material selected from the group of: polypropylene, polystyrene, Teflon, silicone rubber.

6. The chemical analyzer probe of claim 1 wherein the porous tubular filter comprises glass frit.

7. The chemical analyzer probe of claim 1 wherein the porous tubular filter comprises ceramic.

8. The chemical analyzer probe of claim 1 wherein the porous tubular filter comprises hastalloy.

9. The chemical analyzer probe of claim 1 wherein the porous tubular filter comprises nickel.

10. The chemical analyzer probe of claim 1 wherein the porous tubular filter comprises a composite material.

11. The chemical analyzer probe of claim 1 wherein the porous tubular filter has wall thickness that does not exceed 1 mm.

12. The chemical analyzer probe of claim 1 wherein the porous tubular filter blocks flow of particles from the process fluid to the filter fluid.

13. The chemical analyzer probe of claim 1 wherein the sensor comprises a pH sensor.

14. The chemical analyzer probe of claim 1 wherein the sensor comprises an ISFET sensor.

15. The chemical analyzer probe of claim 1 wherein the sensor comprises a contacting fluid conductivity sensor.

16. The chemical analyzer probe of claim 1 wherein the sensor comprises a non contact conductivity sensor.

17. The chemical analyzer probe of claim 1 wherein the sensor comprises a gas sensor.

18. The chemical analyzer probe of claim 1 wherein the sensor comprises an ion specific sensor.

19. The chemical analyzer probe of claim 1 wherein the filter fluid comprises a portion of the process fluid selected by the coating.

20. The chemical analyzer probe of claim 1 wherein the filter fluid comprises a buffer solution and a portion of the process fluid selected by the coating.

21. The chemical analyzer probe of claim 1 wherein the second chemical comprises a corrosive chemical selected from the group: SO3, H2SO4, HCl, NH3.

22. The chemical analyzer probe of claim 1 wherein the sealing surface has a shape that conforms to 3A sanitary standards.

23. A method of manufacturing a chemical analyzer probe insertable in an opening in a container of process fluid, comprising:
shaping a gland to extend from a tubular end insertable in the opening to a second gland end connectable to a chemical analyzer, and shaping a sealing surface on the gland to seal to the opening;
providing a porous tubular filter extending to a closed end in the process fluid to form a filter cavity holding a filter fluid;
joining the porous tubular filter to the tubular end;
depositing a coating on the porous tubular filter; the coating being formed of a chemically selective material to allow a first chemical in the process fluid to flow into the filter fluid, and to exclude a second chemical in the process fluid; and
coupling a sensor to the filter fluid for sensing; the sensor being connectable to a chemical analyzer through the second gland end.
